(19) United States
(12) Patent Application Publication
(10) Pub. No.: US 2015/0063672 A1
(43) Pub. Date: Mar. 5, 2015

(54) VALUABLE DOCUMENT RECOGNITION SYSTEM WITH QR CODE RECOGNIZABILITY

(71) Applicant: International Currency Technologies Corporation, Taipei (TW)

(72) Inventor: CHIA-MIN CHANG, TAIPEI (TW)

(73) Assignee: International Currency Technologies Corporation, Taipei (TW)

(21) Appl. No.: 14/051,668

(22) Filed: Oct. 11, 2013

(30) Foreign Application Priority Data
Aug. 29, 2013 (TW) 102216235

(51) Int. Cl. G07D 7/20; G07D 7/00

(52) U.S. Cl. CPC G07D 7/2033; G07D 7/0006
USPC 382/135

(57) ABSTRACT

A valuable document recognition system includes a main unit, and a circuit module including a microprocessor, a sensor unit for detecting the position of an inserted valuable document, a recognition module using an image pickup device and a bill recognition device for recognizing the authenticity, value and QR code of an inserted valuable document and a data storage module that includes a decode database having stored therein decode data corresponding the QR codes of predetermined valuable documents and a characteristic database having stored therein characteristic data corresponding to the anti-counterfeit characteristics of predetermined valuable documents. Thus, the valuable document recognition system is capable of recognizing the QR codes and anti-counterfeit characteristics of predetermined valuable documents.

This application claims the priority benefit of Taiwan patent application number 102216235, filed on Aug. 29, 2013.

### BACKGROUND OF THE INVENTION

1. Field of the Invention

The present invention relates to bill acceptor technology, and more particularly, to a valuable document recognition system with QR code recognizability, which is capable of recognizing the QR codes and anti-counterfeit characteristics of predetermined valuable documents.

2. Description of the Related Art

Following fast development of modern technology, convenience and rapidness have become important factors in our modern daily life. Nowadays, different automatic vending machines, card dispensers, ticket machines and bill exchange machines are used everywhere to sell different products without serviceman. These machines are highly appreciated for the advantage of saving much labor and bringing convenience to people.

In our daily life, we use cash, credit card, cash card, debit card or intelligent card to pay for purchases. However, some particular places, such as amusement center, park, casino, etc., may not accept credit card. These particular places may use a valuable document, such as paper token or special security for access or payment. A valuable document for this purpose may be equipped with a barcode for recognition. However, a barcode is a one-dimensional format that has a low level of storage capacity and security. Further, reading a barcode needs to use a barcode scanner. Using a barcode scanner to scan the barcodes of a large amount of different valuable documents requires much labor. In order to save code reading time and labor and to improve the code reading accuracy and security, a two-dimensional QR (quick response) code system is created. In consequence, there is a strong demand for a valuable document recognition system capable for recognizing QR (quick response) codes.

### SUMMARY OF THE INVENTION

The present invention has been accomplished under the circumstances in view. It is therefore one object of the present invention to provide a valuable document recognition system with QR code recognizability, which is capable of recognizing the authenticity and value of predetermined valuable documents as well as their QR codes.

To achieve this and other objects of the present invention, a valuable document recognition system of the present invention comprises a main unit, and a circuit module mounted in the main unit. The circuit module comprises a circuit board, a microprocessor installed in the circuit board, a recognition module installed in the circuit board and electrically connected to the microprocessor, the recognition module comprising an image pickup device for picking up the image of a valuable paper and a bill recognition device for capturing and recognizing the anti-counterfeit characteristics of a valuable document, and a data storage module installed in the circuit board and electrically connected to the microprocessor, the data storage module comprising a decode database having stored therein decode data corresponding the quick response codes of predetermined valuable documents for matching and a characteristic database having stored therein characteristic data corresponding to the anti-counterfeit characteristics of predetermined valuable document for matching.

### BRIEF DESCRIPTION OF THE DRAWINGS

FIG. 1 is an oblique top elevational view of a valuable document recognition system in accordance with the present invention.

FIG. 2 is an exploded view of the Valuable document recognition system in accordance with the present invention.

FIG. 3 is a sectional view, in an enlarged scale, of a part of the valuable document recognition system in accordance with the present invention.

FIG. 4 is a circuit block diagram of the present invention.

FIG. 5 is an exploded view of an alternate form of the valuable document recognition system in accordance with the present invention.

FIG. 6 is a sectional view, in an enlarged scale, of a part of the alternate form of valuable document recognition system shown in FIG. 5.

FIG. 7 is a schematic drawing illustrating applicability of the valuable document recognition system in accordance with the present invention.

### DETAILED DESCRIPTION OF THE PREFERRED EMBODIMENT

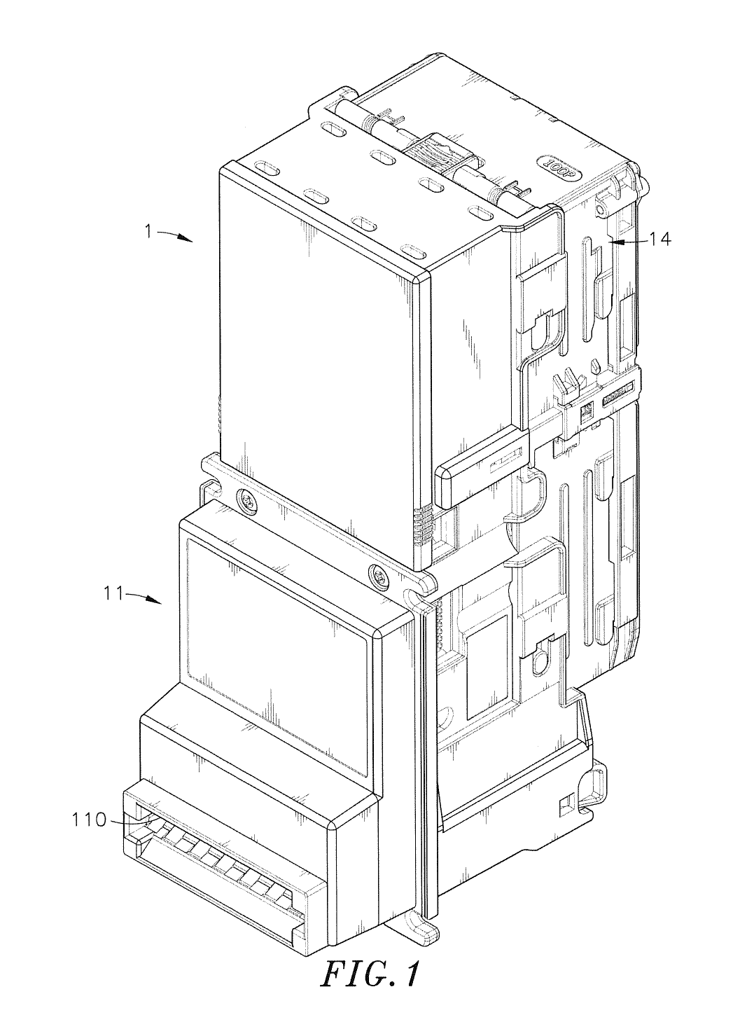

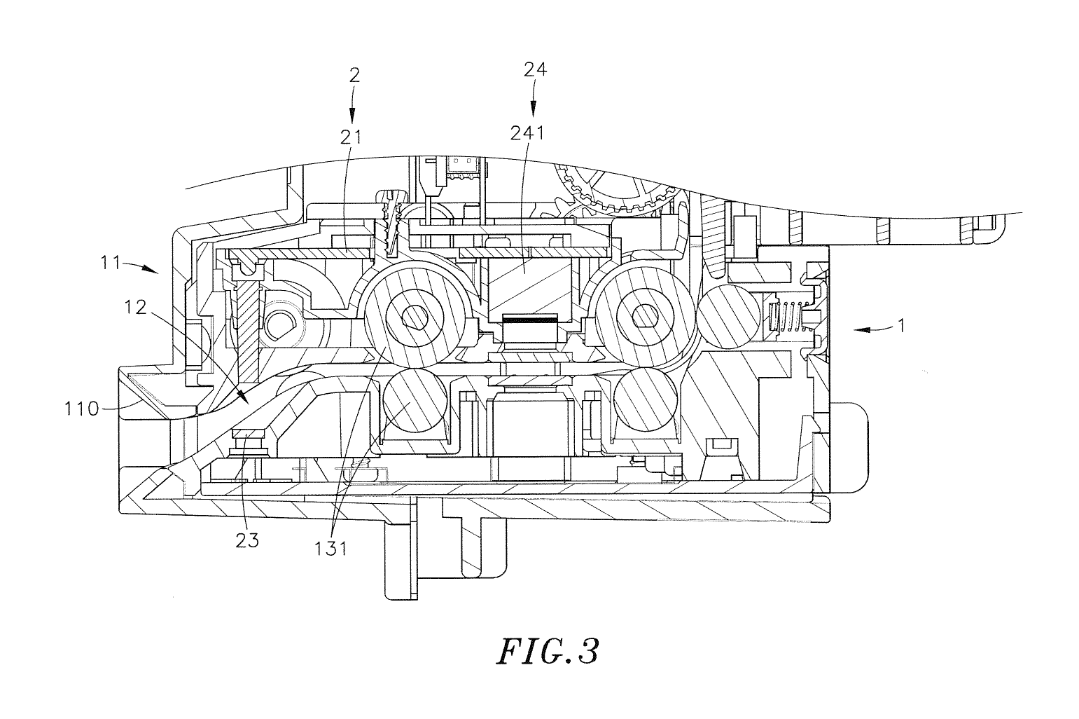

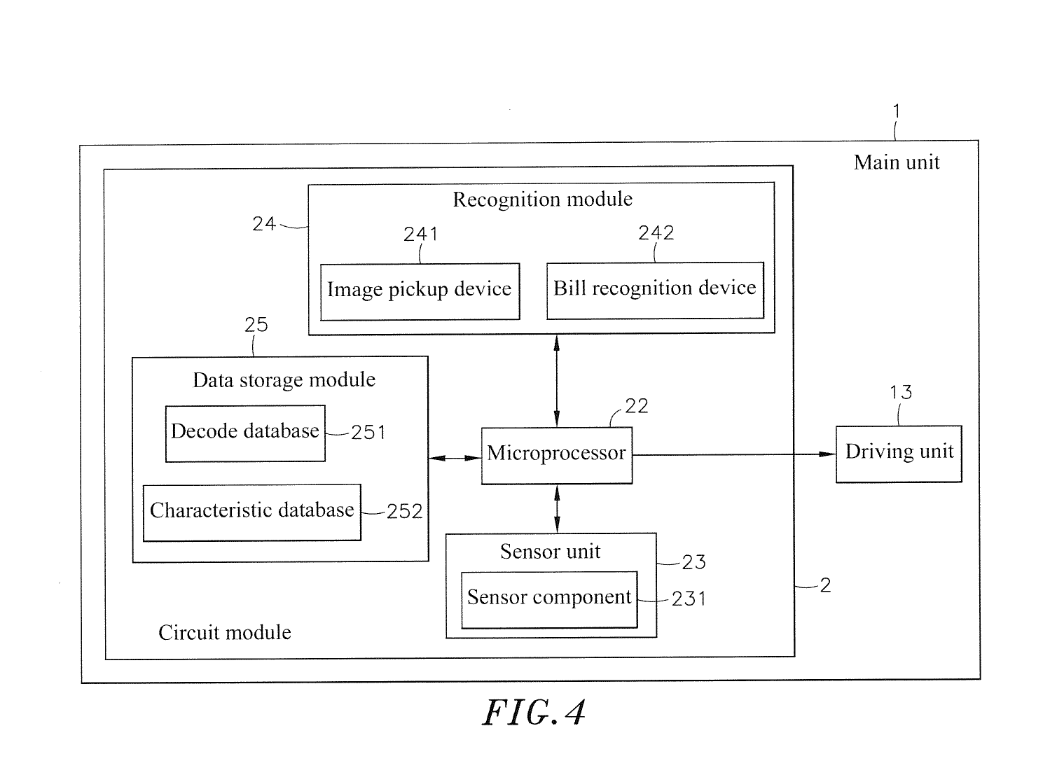

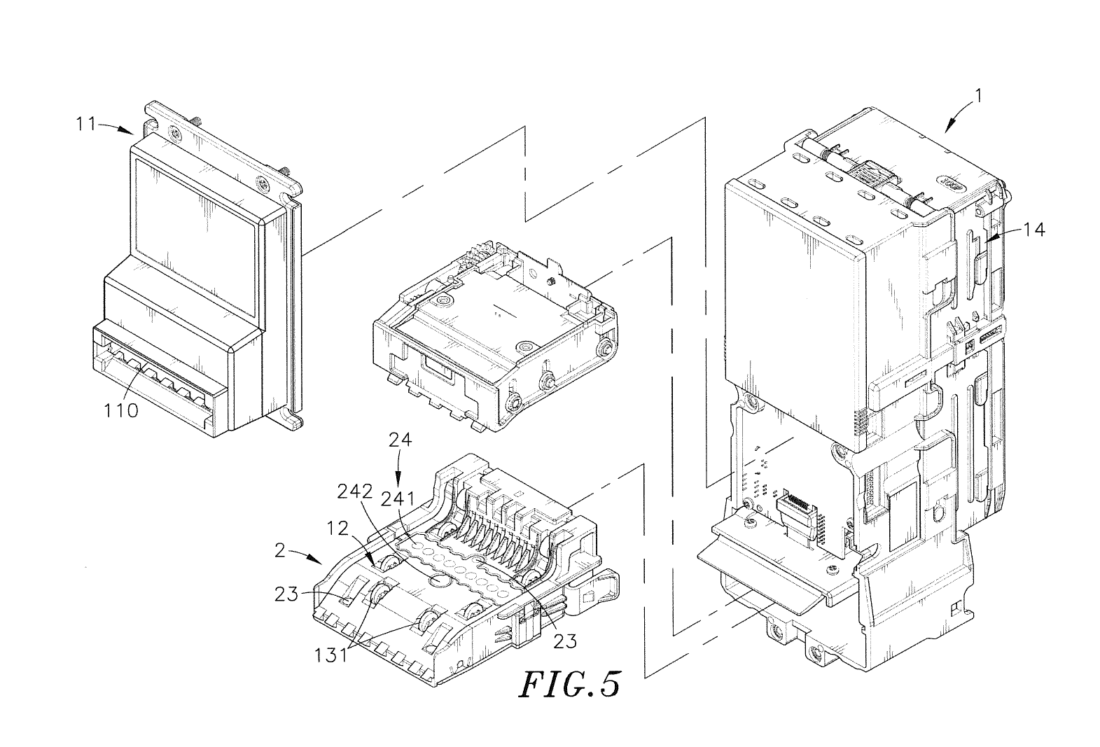

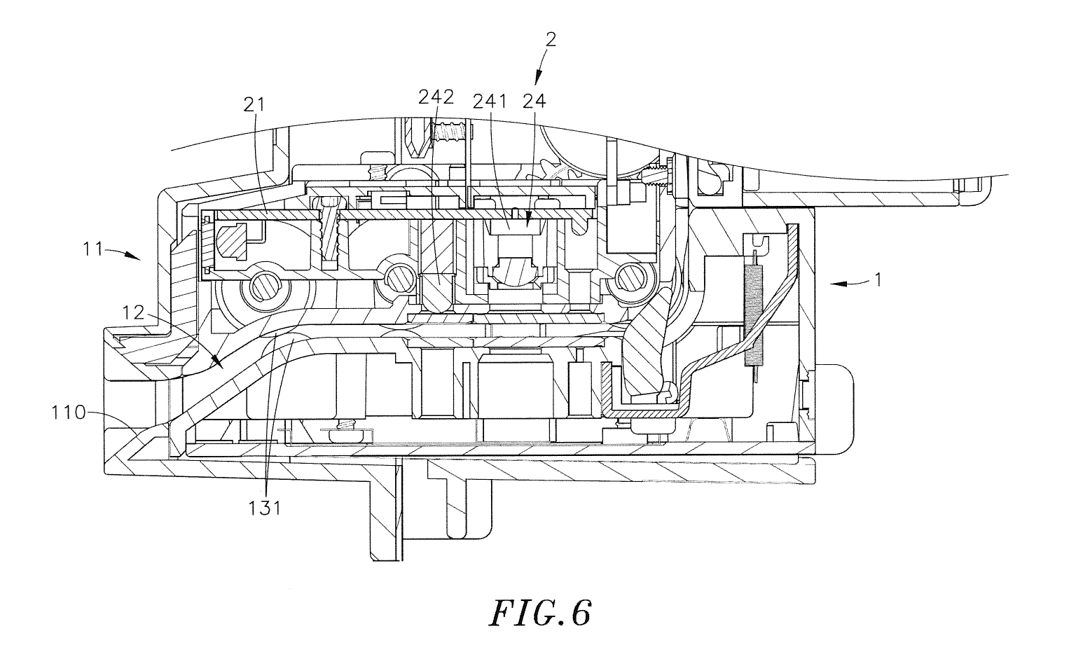

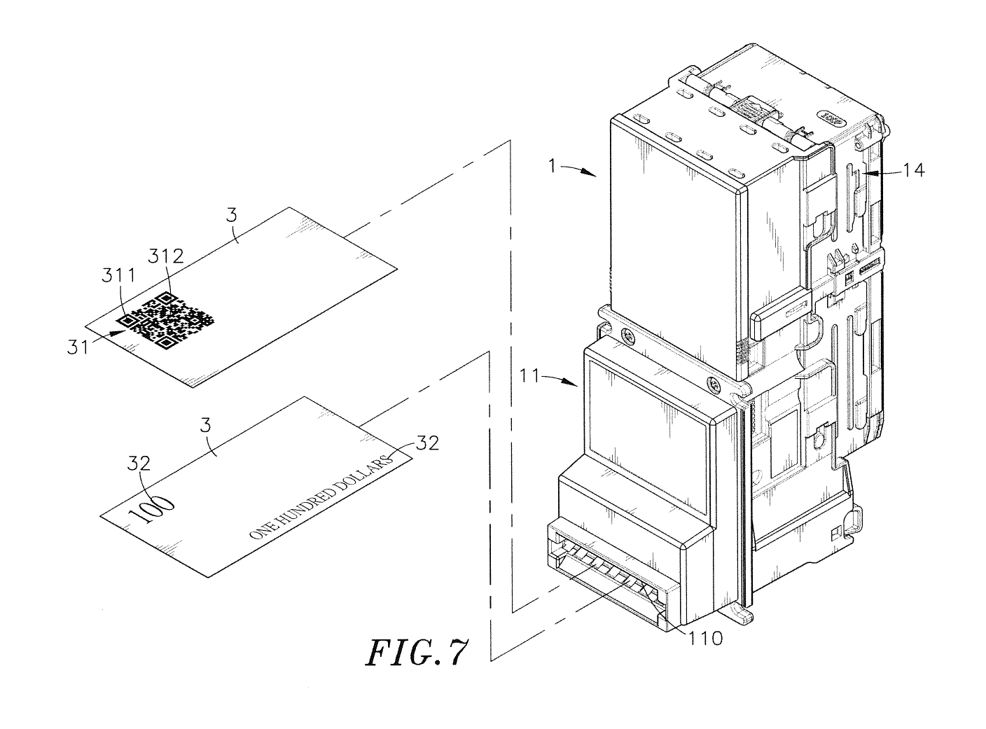

Referring to FIGS. 1-7, a valuable document recognition system with QR code recognizability in accordance with the present invention is shown. The valuable document recognition system comprises a main unit 1, and a circuit module 2.

The main unit 1 comprises a face panel 11 defining a bill slot 110 for the insertion of a valuable document 3, a bill passage 12 backwardly extended from the bill slot 110, a bill box 14 mounted in a back side thereof for receiving each valuable document passing through the bill passage 12, a driving unit 13, and a plurality of bill-transfer rollers 131 symmetrically mounted in the bill passage 12 at two opposite lateral sides and rotatable by the driving unit 13 to transfer each inserted valuable document 3 from the bill slot 110 through the bill passage 12 to the bill box 14.

The circuit module 2 is mounted in the main unit 1, comprising at least one circuit board 21, a microprocessor 22 installed in the at least one circuit board 21 and electrically connected with the driving unit 13 for controlling the operation of the driving unit 13, a sensor unit 23 installed in the at least one circuit board 21 and electrically connected to the microprocessor 22, a recognition module 24 installed in the at least one circuit board 21 and electrically connected to the microprocessor 22, and a data storage module 25 installed in the at least one circuit board 21 and electrically connected to the microprocessor 22. The sensor unit 23 comprises a plurality of sensor components 231 arranged in the bill passage 12 near the bill slot 110. The recognition module 24 comprises an image pickup device 241 for picking up the image of each inserted valuable document 3 that is being delivered through the bill passage 1. The data storage module 25 comprises a decode database 251 that has stored therein decode data corresponding a QR (quick response) code 31 in one surface of one respective predetermined valuable document 3, and a characteristic database 252 that has stored therein characteristic data corresponding to one respective anti-counterfeit characteristic 32 in one surface of one respective predetermined valuable document 3.

During application, a valuable document 3 having a QR (quick response) code 31 and/or at least one anti-counterfeit characteristic 32 in one surface thereof is inserted into the bill slot 110 in the face panel 11 of the main unit 1 by a user. At this time, the sensor components 231 of the sensor unit 23 sense the insertion of the valuable document 3 and provide a signal to the microprocessor 22, causing the microprocessor 22 to start up the driving unit 13 in rotating the bill-transfer rollers 131, and thus, the inserted valuable document 3 is transferred by the bill-transfer rollers 131 from the bill slot 110 toward the inner side of the bill passage 12. At the same time, the microprocessor 22 drives the image pickup device 241 of the recognition module 24 to pick up the image of the valuable document 3, and the sensor components 231 of the sensor unit 23 keep sensing the movement of the valuable document 3. When the valuable document 3 passed through the image pickup device 241 of the recognition module 24, the sensor unit 23 immediately provides a signal to the microprocessor 22, causing the microprocessor 22 to stop the driving unit 13. At this time, the recognition module 24 transfers the image data picked up by the image pickup device 241 from the surface of the valuable document 3 to the microprocessor 22 for analysis. After analysis, the microprocessor 22 obtains the data of the anti-counterfeit characteristic(s) 32 on the surface of the valuable document 3, and compares the fetched data of the anti-counterfeit characteristic(s) 32 with storage data in the characteristic database 252 to determine the authenticity and value of the valuable document 3. Further, if the valuable document 3 provides a QR (quick response) code 31, the microprocessor 22 compares the QR (quick response) code 31 with storage data in the decode database 251 to obtain the data content of the QR (quick response) code 31 for further follow-up processing. Thus, a single valuable document recognition system in accordance with the present invention can recognize the authenticity and value of predetermined valuable documents 3 and its data content, saving much machine installation space and document (security) handling labor costs.

Further, a valuable document recognition system in accordance with the present invention can be used to recognize the authenticity and value of any of a variety of valuable documents 3, such as paper money, securities, paper tokens, and etc. If one inserted valuable document 3 is recognized to be a true valuable document by the microprocessor 22 by means of the recognition module 24, the microprocessor 22 immediately controls the driving unit 13 to rotate the bill-transfer rollers 131, transferring the valuable document 3 through the bill passage 12 to the bill box 14. If one inserted valuable document 3 is recognized to be a counterfeit, the microprocessor 22 immediately controls the driving unit 13 to reverse the bill-transfer rollers 131, carrying the valuable document 3 back toward the outside of the bill slot 110.

Further, when a user is going to insert a valuable document 3 that provides a QR (quick response) code 31, the user must insert the valuable document 3 with the side that carries the QR (quick response) code 31 facing toward the image pickup device 241 of the recognition module 24 in the bill passage 12. Further, the image pickup device 241 of the recognition module 24 can be a CCD (charge-coupled device) image sensor, CMOS (complementary metal-oxide-semiconductor) image sensor, CCM (compact camera module), CIS (contact image sensor) or any other optical device capable of picking up the surface image of a valuable document 3. Further, the QR (quick response) code 31 works in a rectangular format, having three position detection patterns 311 located in three of the four corners and one information detection pattern 312 located in the other area. The image pickup device 241 of the recognition module 24 picks up the image of the QR (quick response) code 31 at one time or multiple times, enabling the microprocessor 22 to analyze the three position detection patterns 311 for positioning to fetch the QR (quick response) code 31, and then compares the data of the information detection pattern 312 with storage data in the decode database 251 of the data storage module 25 so as to get the related information.

Further, a QR Code contains its own error correction data, internal orientation calibration and self-alignment markers. Whether the QR code is upside down or wrapped around a curved surface, or 7%˜30% damaged, the message will still get through. Further, a standard QR Code is a 21×21 array of data elements with the array increasing in size by 4 modules for each increase in version number. A QR code has the data capacity of numeric only: max. 7,089 characters; alphanumeric: max. 4,296 characters; binary (8 bits): max. 2,953 bytes; Kanji/Kana: max. 1,817 characters. Thus, the desired information can be put in the information detection pattern 312.

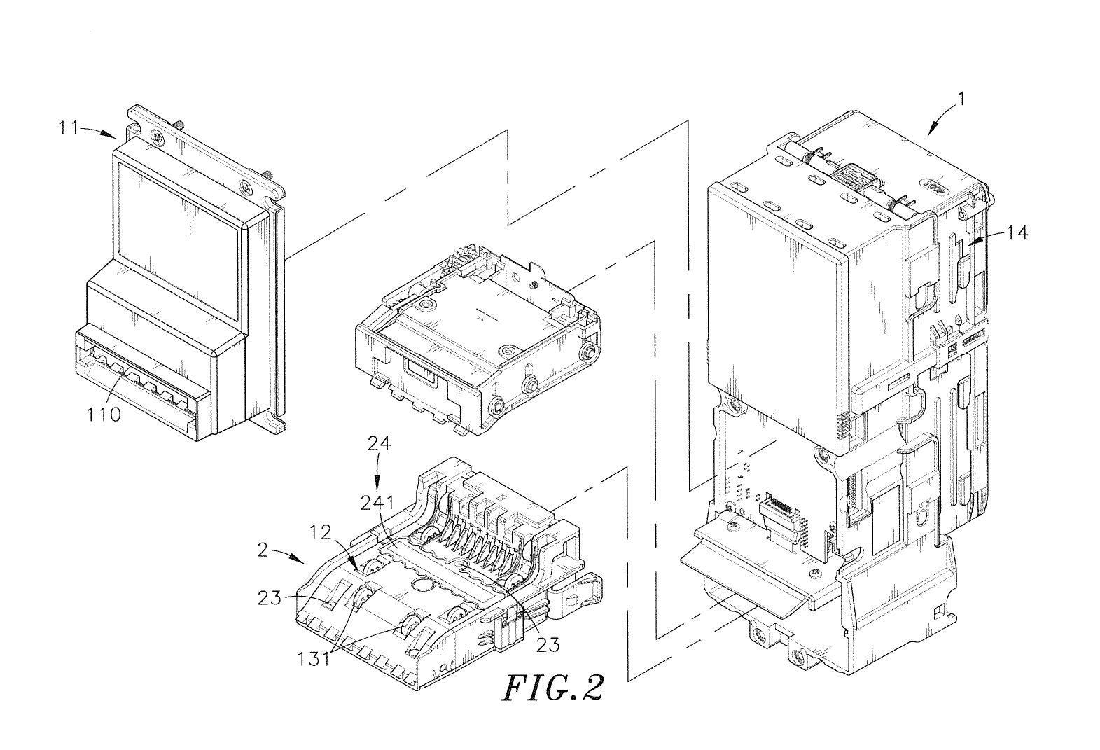

Referring to FIGS. 2-7 again, in addition to the image pickup device 241 for picking up the image of each inserted valuable document 3, the recognition module 24 further comprises a bill recognition device 242 mounted in one lateral side of the bill passage 12 opposite to the image pickup device 241 for fetching at least one anti-counterfeit characteristic 32 of each inserted valuable document 3 for recognition. Subject to the functioning of the image pickup device 241 and the bill recognition device 242, the invention double-checks the authenticity and value of each inserted valuable document 3.

The aforesaid technology of capturing and recognizing the anti-counterfeit characteristic 32 can be an image capturing and recognition technique, infrared scanning and recognition technique, ultraviolet ray scanning and recognition technique, laser tag scanning and recognition technique, or watermark scanning and recognition technique. Further, the bill recognition device 242 can be an optical penetration-based sensor device, or a reflection-based optical sensor device. As the technology of capturing and recognizing the anti-counterfeit characteristic 32 is of the known art and not within the scope of the claims of the present invention, no further detailed description in this regard will be necessary.

In conclusion, the invention provides a valuable document recognition system, which comprises a main unit 1, and a circuit module 2 consisting of at least one circuit board 21, a microprocessor 22, a sensor unit 23, a recognition module 24 and a data storage module 25 and mounted in the main unit 1, wherein the recognition module 24 comprises an image pickup device 241 for picking up the image of each inserted valuable document 3; the data storage module 25 comprises a decode database 251 that has stored therein decode data corresponding a QR (quick response) code 31 on one surface of one respective predetermined valuable document 3, and a characteristic database 252 that has stored therein characteristic data corresponding to the anti-counterfeit characteristics 32 on one surface of one respective predetermined valuable document 3. Thus, the valuable document recognition system of the invention is capable of recognizing the QR (quick response) codes 31 and anti-counterfeit characteristics 32 of predetermined valuable documents 3.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A valuable document recognition system for recognizing the authenticity, value and quick response code of a predetermined valuable document that carries a quick response code and at least one anti-counterfeit characteristic, comprising:
a main unit comprising a face panel defining a bill slot for the insertion of said valuable document, a bill passage backwardly extended from said bill slot, a bill box mounted in a back side thereof for receiving said valuable document, a driving unit, and a plurality of bill-transfer rollers symmetrically mounted in said bill passage at two opposite lateral sides and rotatable by said driving unit to transfer said valuable document from said bill slot through said bill passage to said bill box; and
a circuit module mounted in said main unit, said circuit module comprising at least one circuit board, a microprocessor installed in said at least one circuit board and adapted for controlling the operation of said driving unit, a recognition module installed in said at least one circuit board and electrically connected to said microprocessor, said recognition module comprising an image pickup device and being adapted for picking up the image of said valuable document, and a data storage module installed in said at least one circuit board and electrically connected to said microprocessor, said data storage module comprising a decode database having stored therein decode data corresponding said quick response code of said valuable document and a characteristic database having stored therein characteristic data corresponding to said at least one anti-counterfeit characteristic of said valuable document.

2. The valuable document recognition system as claimed in claim 1, wherein said circuit module further comprises a sensor unit installed in said at least one circuit board and electrically connected to said microprocessor, said sensor unit comprising a plurality of sensor components arranged in said bill passage for detecting the position of said valuable document in said bill slot and said bill passage.

3. The valuable document recognition system as claimed in claim 1, wherein said image pickup device of said recognition module is selected from the group of CCD (charge-coupled device) image sensor, CMOS (complementary metal-oxide-semiconductor) image sensor, CCM (compact camera module) and CIS (contact image sensor).

4. A valuable document recognition system for recognizing the authenticity, value and quick response code of a predetermined valuable document that carries a quick response code and at least one anti-counterfeit characteristic, comprising:
a main unit comprising a face panel defining a bill slot for the insertion of said valuable document, a bill passage backwardly extended from said bill slot, a bill box mounted in a back side thereof for receiving said valuable document, a driving unit, and a plurality of bill-transfer rollers symmetrically mounted in said bill passage at two opposite lateral sides and rotatable by said driving unit to transfer said valuable document from said bill slot through said bill passage to said bill box; and
a circuit module mounted in said main unit, said circuit module comprising at least one circuit board, a microprocessor installed in said at least one circuit board and adapted for controlling the operation of said driving unit, a recognition module installed in said at least one circuit board and electrically connected to said microprocessor, said recognition module comprising an image pickup device for picking up the image of said valuable paper and a bill recognition device for capturing and recognizing said at least one anti-counterfeit characteristic of said valuable document, and a data storage module installed in said at least one circuit board and electrically connected to said microprocessor, said data storage module comprising a decode database having stored therein decode data corresponding said quick response code of said valuable document and a characteristic database having stored therein characteristic data corresponding to said at least one anti-counterfeit characteristic of said valuable document.

5. The valuable document recognition system as claimed in claim 4, wherein said circuit module further comprises a sensor unit installed in said at least one circuit board and electrically connected to said microprocessor, said sensor unit comprising a plurality of sensor components arranged in said bill passage for detecting the position of said valuable document in said bill slot and said bill passage.

6. The valuable document recognition system as claimed in claim 4, wherein said image pickup device of said recognition module is selected from the group of CCD (charge-coupled device) image sensor, CMOS (complementary metal-oxide-semiconductor) image sensor, CCM (compact camera module) and CIS (contact image sensor).

7. The valuable document recognition system as claimed in claim 4, wherein said bill recognition device of said recognition module is an optical penetration-based sensor device.

8. The valuable document recognition system as claimed in claim 4, wherein said bill recognition device of said recognition module is a reflection-based optical sensor device.
